(19) United States
(12) Patent Application Publication
(10) Pub. No.: US 2005/0181955 A1
(43) Pub. Date: Aug. 18, 2005

(54) Method of producing Mn alloy sputtering target and Mn alloy sputtering target produced through the production method

(75) Inventor: Kazuteru Kato, Omuta-shi (JP)

Correspondence Address: Richard S. Roberts;ROBERTS & ROBERTS, L.L.P., P.O. Box 484, Princeton, NJ, 08542-0484, US

(73) Assignee: Mitsui Mining & Smelting Co., Ltd.

(21) Appl. No.: 11/036,552

(22) Filed: Jan. 14, 2005

(30) Foreign Application Priority Data
Feb. 18, 2004 (JP) P2004-041176

(51) Int. Cl. C04B 2/00

(52) U.S. Cl. 505/511

(57) ABSTRACT

The provided is a producing technology for an Mn alloy sputtering target having low contents of impurity components such as oxygen, carbon and nitrogen and controlled crystal conformation. The present invention is characterized by the production steps of: adding deoxidant comprising elements having stronger affinity for oxygen than that of Mn to Mn; subjecting the Mn to a deoxidization-melting treatment in a fire-resistant crucible to prepare low-oxygen Mn, in which Mn is melted until oxide of the added deoxidant floats in the Mn molten metal; mixing the low-oxygen Mn with constituent metals of a sputtering target by respective predetermined amounts; adding further the deoxidant to the mixture; vacuum melting the mixture; and subjecting the mixture to a casting treatment.

### BACKGROUND OF THE INVENTION

1. Field of the Invention

The present invention relates to a method of producing a sputtering target, more particularly to a method of producing a Mn alloy sputtering target of low oxygen, low carbon and low nitrogen.

2. Earlier Technologies

In a Mn alloy sputtering target related to the present invention, alloys for example of Pt—Mn, Ir—Mn and Ni—Mn have been adopted, and used for forming a magnetic head, magnetic media and MRAM (i.e. Magnetoresistive Random Access Memory) for a hard disk drive. A magnetic device provided with an antiferromagnetic layer formed of these Mn alloys is composed of a multilayer film, and a ferromagnetic layer is formed adjacently to the antiferromagnetic layer. The antiferromagnetic layer has an advantageous of stabilizing or firmly fixing magnetization of the ferromagnetic layer in single direction.

However, if such impurity components as for example oxygen and carbon exist in large quantity within a thin film formed of a Mn alloy, the effect of the antiferromagnetic layer tends to deteriorate. Therefore, a Mn alloy sputtering target being used for formation of an antiferromagnetic layer is desired of low oxygen and low carbon.

In a process of a film formation in sputtering, a surface of a sputtering target becomes irregular in proportion to the crystal grain size when etching is advanced through sputtering. Specifically, when the grain size of the crystal composing the sputtering target is large, the irregularity of the surface caused by sputtering becomes remarkable, thereby sometimes causing an abnormal discharge or dust during a sputtering film formation. Such phenomena are more likely to deteriorate the quality of a formed film in the form of disordered crystal system, disturbed composition, and increased quantity of impurities. Such a deteriorated thin film will also not be fully satisfying in terms of an antiferromagnetic property. Consequently, sputtering targets with a fine crystal grain size have been demanded.

As discussed above, it has been demanded to a Mn alloy sputtering target being used for formation of an antiferromagnetic layer that the target should have such material properties as reduced impurity components like oxygen or carbon, as well as fine crystal grains. To materialize such material properties, various production technologies has been proposed.

First of all, in connection with the quantity of oxygen in a Mn alloy sputtering target, Japanese Patent Application Laid-open No. 2000-160332 (referred to as Patent Document 1) and International Publication No. 98/022636 (referred to as Patent Document 2) disclose a sputtering target in which the oxygen content is defined. These prior art define the oxygen content in the target materials as 1 wt % or less and further as 250 ppm or lower. The object of the definition is mainly for high density in a case where a sputtering target is produced through a sintering method and improvement of both workability and toughness of a sputtering target in a case of a gravity casting method, and is thus assumed improvement of problems in producing. Although an allowable value of impurity components in a thin film forming an antiferromagnetic layer is not necessarily clear, it is expected that more preferable antiferromagnetic properties can be achieved only when the oxygen content in a Mn alloy sputtering target is lower than at least about 100 ppm, when a fact that the oxygen content in a sputtering target used for formation of a ferromagnetic layer is 100 ppm or lower is taken into consideration.

In the meantime, two well-known production methods of a sputtering target are divided roughly into a sintering method and a meltage sintering method. The sintering method comprises the steps of: mixing and adjusting either Mn alloy powder or metallic powder including elements composing Mn alloy; and sintering through for example a hot pressing to provide sputtering target. The above Patent Documents 1 and 2 teach even a normal sintering method can provide a Mn alloy sputtering target with low oxygen. Actually, however, since Mn powder per se as a raw material has as much oxygen content as about 800 ppm or higher, it is presumed very difficult to adjust the oxygen content in the target materials to 100 ppm or lower with respect to a sputtering target having a component ratio of Mn 20-30 wt % for developing antiferromagnetic properties. The Patent Documents 1 and 2 further refer to a meltage sintering method and teach that a Mn alloy sputtering target with low oxygen can be provided through a normal vacuum melting method. However, as far as the present inventor's research and prior art are considered, it is deemed very difficult to provide a low-oxygen Mn alloy sputtering target of 100 ppm or lower if deoxidation treatment as discussed later is not conducted.

A technique for reducing oxygen content Mn per se has, which is used for production, is adopted in producing a Mn alloy sputtering target with low oxygen. For example, a distilling method for deoxidation of Mn as disclosed in Japanese Patent Application Laid-open No. 1999-152528 (referred to as Patent Document 3) is known. It is a well-known technology to employ the distilling method for highly purifying such substances as Zn and Pb, which have a low melting point and a high vapor pressure. Since Mn also has a high vapor pressure, it will be possible to adopt the distilling method. However, as Japanese Patent Application Laid-open No. 2001-220665 (referred to as Patent Document 4) teaches, a distilling method is a challenged technology if industrially used in terms of process yield, production efficiency and safety, and further with respect to such alloys as Mn with a melting point exceeding 1000° C.

Japanese Patent Application Laid-open No. 1987-116734 (referred to as Patent Document 5) discloses a fire-resistant calcia crucible, which contains calcium as a constituent element having stronger affinity for oxygen than that of Mn is able to deoxidize Mn. The present inventor has confirmed through their research that Mn can be deoxidized to some degree when Mn is melted with the use of a fire-resistant calcia crucible, which has stronger affinity for oxygen than that of Mn. However, it is presumed very difficult to obtain a low-oxygen Mn alloy sputtering target with an oxygen content of 100 ppm or lower even if such a fire-resistant calcia crucible alone is used. Furthermore, Patent Document 4 discloses a technology of deoxidizing Mn through an induction scull melting. However, most of the oxygen contained in a Mn alloy sputtering target is a carryover from a Mn raw material per se, so that it is presumed there is a limit to lowering oxygen in a Mn alloy sputtering target through an induction scull melting in which deoxidation is carried out through vacuum melting while oxygen contamination from a crucible for meltage is prevented. Additionally, Japanese Patent Application Laid-open No. 2001-59167 (referred to as Patent Document 6) discloses a technology in which an element having a greater affinity for oxygen than that of Mn is used as a deoxidizer. However, Patent Document 6 defines the amount to be added to 10-100 ppm in consideration of that deoxidant elements and oxides thereof tend to remain as residues in the Mn alloy sputtering target, which will adversely affect during a fihn formation. However, it is considered such a degree of addition of deoxidant is insufficient, and hence will be very difficult produce a Mn alloy sputtering target with low oxygen content of 100 ppm or lower.

Although Patent Documents 1-3 and Japanese Patent Application Laid-open No. 1999-1006311 (referred to as Patent Document 7) teach effectivity or the like of low carbon, they teach little about how to reduce the carbon in a specific manner.

Further, with respect to the size of crystal grains constituting Mn alloy sputtering target, Japanese Patent Application Laid-open No. 2001-26861 (referred to as Patent Document 8) discloses a platinum group—Mn-based alloy sputtering target, which is composed of crystal structure having dendrite texture and length of the main dendrite thereof has been defined. However, this prior art is exclusively devoted to solving problems in producing for improving the strength of a target, and hence it is assumed difficult to provide a Mn alloy sputtering target which can fully inhibit an abnormal electric discharge and dust during sputter deposition.

### SUMMARY OF THE INVENTION

The present invention was made in view of the above-described background, and provides a technology for producing in a facilitated manner for an Mn alloy sputtering target having low contents of impurity components such as oxygen and carbon and a controlled crystal conformation.

The present inventor conducted an intensive study on methods of producing a sputtering target via a gravity casting method in order to solve the above problems, and consequently discovered a technique for readily separating, from Mn molten metal, oxide which will generate from additive elements even when any elements having strong affinity for oxygen are added to and melted in a material having low vapor pressure such as Mn, and finally came up with the present invention.

The method of producing a Mn alloy sputtering target according to the present invention is characterized by the steps of: adding deoxidant to Mn, the deoxidant comprising elements having stronger affinity for oxygen than that of Mn; subjecting the Mn to a deoxidization-melting treatment in a fire-resistant crucible to prepare low-oxygen Mn, in which Mn is melted to allow oxide generating due to the added deoxidant to float from the Mn molten metal; mixing the low-oxygen Mn with constituent metals of a sputtering target by respective predetermined amounts; further adding the deoxidant to the mixture; vacuum melting the mixture; and subjecting the mixture to a casting treatment.

When a deoxidant composed of elements having a greater affinity for oxygen than that of Mn is added to and melted in Mn, oxide of the added elements remains in Mn and resultingly gets mixed in an Mn alloy sputtering target, thereby Patent Document 6 being aware of it restricted an additive amount of a deoxidizer. However, the present inventor discovered securing a certain degree of melting time even if a deoxidant is added can readily inhibit the oxide from mixing in a Mn ingot. A mechanism of the phenomenon has not been fully understood, however it is considered ascribable to that adjustment of time for melting Mn to which a deoxidant has been added causes floatation of the oxide in the Mn molten metal due to difference in specific gravity between the Mn molten metal and the oxide being generated via an added deoxidant.

The method of producing a Mn alloy sputtering target according to the present invention employs a low-oxygen Mn which has been inhibited an oxide from getting mixed, mixes the low-oxygen Mn with constituent metals of a sputtering target by respective predetermined amounts, further adds the deoxidant to the mixture; vacuum melts the mixture; and subjects the mixture to a casting treatment, to allows a Mn alloy sputtering target with low content of nitrogen as well as low contents of oxygen and carbon.

In the present method of producing a Mn alloy sputtering target, it is preferable to use a calcia crucible as a fire-resistant crucible. This is because a calcia crucible has a deoxidization effect.

As a deoxidant in the present invention, it is preferable to use at least one or more than one selected from a group consisting of Al, Ti, Ca, Mg, Ce, Si, B, V, Zr and Hf, and it is preferable if an added amount is 0.1 wt %-2.0 wt % with respect to Mn. The reason is that the elements Al, Ti, Ca, Mg, Ce, Si, B, V, Zr and Hf have stronger affinity for oxygen than that of Mn. Low-oxygen can be achieved if the element(s) added correspond(s) to the oxygen quantity Mn itself possesses. However, it has been confirmed that it is preferable to add 0.1 wt % or more when a low-oxygen Mn alloy sputtering target of 100 ppm or lower is to be produced. Incidentally, when an added quantity exceeds 2.0 wt %, little difference will be made in an effect of reducing oxygen, and oxide will more likely to remain.

The inventor's research confirmed mixture of carbon into Mn derives from a casting mold used in a casting process. Specifically, it was turned out that a melting temperature of Mn exceeds the melting point of Mn (1246° C.) by 100° C. or higher in a casting process, the concentration of carbon mixed will rise. That is why, it is preferable to conduct a Mn deoxidation treatment at a melting temperature in the range of 1260° C. through 1400° C. in producing a low-oxygen Mn alloy sputtering target. When the temperature is lower than 1260° C., melting of Mn will be insufficient, thereby making it difficult for Mn to have low-oxygen. In contrast, when the temperature exceeds 1400° C., concentration of carbon mixed is more likely to rise remarkably.

It is preferable if the deoxidation treatment according to the present invention is carried out at the above-described melting temperature for 1 minute or longer. The reason is that if the duration of the melting process is shorter than 1 minute, it is more likely to assume a state where an oxide generated does not float completely in the Mn molten metal, thereby much oxide remains in a Mn ingot. A deoxidation treatment carried out in excess of 60 minutes will make little difference in an amount of oxide removable from a low-oxygen Mn, so that Mn melting has only to be done for 1-60 minutes in a practical sense.

Further in the method of producing a Mn alloy sputtering target according to the present invention, it is desirable to add, as a compound additive to the deoxidant, at least one or two or more elements selected from the group consisting of Si, B, Ba, Zr, Na, Ca, Mg, Ti, and Hf. A mechanism of a phenomenon where the compound additive to the deoxidant facilitates oxide to be removed from Mn molten metal has not been fully understood. However, it is considered ascribable to that compound oxide is formed through addition of the compound additive, and which oxide is readily separated from the Mn molten metal due to for example surface tension or basicity with respect to Mn molten metal, thereby being likely to float to the surface of the molten metal, or alternatively that oxidation of the deoxidant is effectively promoted.

Yet in the method of producing a Mn alloy sputtering target according to the present invention, where low-oxygen Mn and constituent metals of a sputtering target are mixed together by respective predetermined amounts, the deoxidant is added, the mixture is vacuum melted, and the mixture is subjected to a casting treatment. In the casting treatment, it is desirable to carry out the following steps. Specifically, the vacuum-melted molten metal is charged into a casting mold, which has a difference in solidification rate between a solidification initiating side thereof and a solidification terminating side thereof, and the molten metal is solidified so as to provide an oriented columnar crystal, and fine crystal grains at the solidification initiating side.

It is widely known to increase a solidification speed in a casting process in order to make the crystals constituting the sputtering target fine. However, if the crystal grains have been made fine but formed as an equiaxed structure, cracks will be easily occurred, thereby workability is likely to deteriorate. Consequently, the inventor produced difference in solidification speed in the casting mold to realize crystal orientation during solidification, thereby obtained a Mn alloy sputtering target having fine crystals at the solidification initiating side. With the Mn alloy sputtering target having a controlled crystal pattern like this, irregularities of a sputtering face caused by sputtering can be controlled not improper with the solidification initiating side where fine crystal grains exist being used as a sputtering face.

In such a casting treatment, the solidification speed in the casting mold can be controlled through an application, on a bottom of the casting mold, for example of a material having greater thermal diffusivity than that used on a lateral face thereof. The inventor confirmed through his research that the difference in solidification speed is desirable if it is in the range of 2-200 mm/sec.

Since carbon contamination occurs from the casting mold in the casting treatment, it is preferable to initiate a casting with the molten metal temperature controlled to 1380° C.-1900° C. This temperature range allows a low-carbon Mn alloy sputtering target to be produced readily.

The above-described method of producing a Mn alloy sputtering target according to the present invention is suitable for sputtering targets of, for example, Mn-Pt alloy, Mn-Ir alloy, and Mn—Ni alloy. The production method allows a Mn alloy sputtering target characterized by an oxygen content of 100 ppm or less, carbon content of 200 ppm or less, and crystal grain size, on the sputtering face of a sputtering target, of 200 ppm or less to be produced readily. Such a sputtering target with low oxygen and low carbon can form a thin film having excellent antiferromagnetism, thereby inhibiting abnormal discharge or dust sufficiently. The production method further allows a Mn alloy sputtering target having a nitrogen content of 10 ppm or less to be produced readily.

As described above, the present invention allows a Mn alloy sputtering target having low content of such impurities as oxygen, carbon, and nitrogen and being properly controlled in term of crystal patterns. Consequently, a thin film having excellent antiferromagnetism can be formed through stable sputtering.

### BRIEF DESCRIPTION OF THE DRAWINGS

FIG. 1 is a graph showing a relationship between amount of deoxidant added and oxygen concentration in a Mn ingot;

FIG. 2 is a graph showing a relationship between a Mn melting time (molten-metal holding time) and Al concentration in a Mn ingot;

FIG. 3 is a graph showing a relationship between a Mn melting temperature and carbon concentration in a Mn ingot;

FIG. 4 is a photograph showing a texture of a sputtered surface observed through an optical microscope (at a magnification of ×50), the sputtered surface being of Mn—Ni alloy sputtering target produced with the use of a casting mold having a solidification temperature gradient;

FIG. 5 is a photograph showing a texture of a cross section of the sputtering target observed in FIG. 4 as observed through an optical microscope (at a magnification of ×50); and

FIG. 6 is a photograph showing a texture of a sputtered surface observed through an optical microscope (at a magnification of ×50), the sputtered surface being of Mn—Ni alloy sputtering target produced with the use of a carbon casting mold having a solidification temperature gradient.

### PREFERRED EXAMPLES

Preferred examples of the present invention is now described with reference to examples and comparative examples. It should be noted that Ni—Mn alloy and Pt—Mn alloy were the objective materials as a Mn alloy sputtering target in the examples.

### EXAMPLE 1

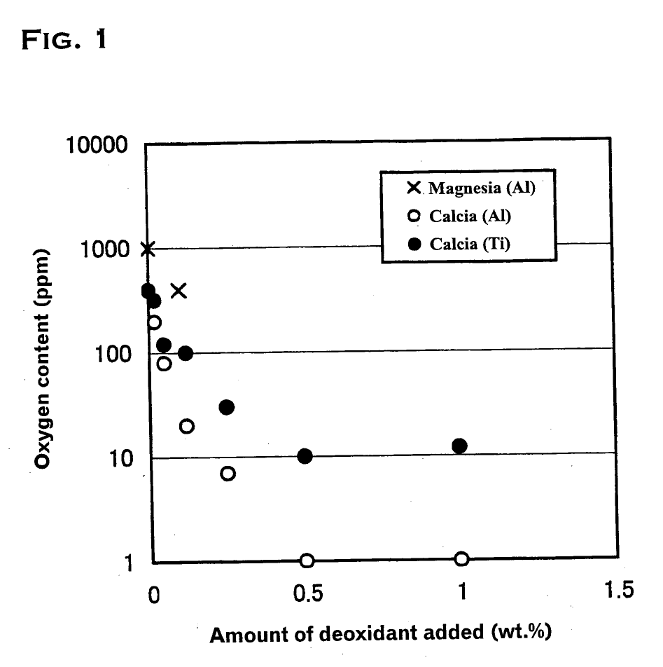

Electrolyzed Mn with an oxygen content of 870 ppm and Al and Ti as a deoxidant were first prepared. Then, the Al and Ti were added to a calcia crucible so as to reach a predetermined concentration with respect to electrolyzed Mn of 1000 g, the Mn was melted at 135° C. in an Ar atmosphere and melted in the calcia crucible, and then casted in a carbon casting mold to produce a Mn ingot having low oxygen. FIG. 1 shows measured results of an oxygen concentration in the ingot where Al and Ti were added to a predetermined concentration.

As FIG. 1 shows, when either Al or Ti of 0.1 wt % or more was added as a deoxidant, the oxygen concentration in the Mn ingot became 100 ppm or lower. In contrast, when a Mn was melted in a calcia crucible with no deoxidant added and casted, the oxygen concentration in the Mn ingot became approximately 400 ppm, which was confirmed lower than the oxygen concentration in the electrolyzed Mn as a raw material, however higher than that to which a deoxidant had been added.

### COMPARATIVE EXAMPLE 1

For the sake of comparison, Al was added as a deoxidant to electrolyzed Mn and the Mn was allowed to melt at 1350° C. in an Ar atmosphere with the use of a magnesia crucible, and then was cast into a carbon mold to produce a Mn ingot having low oxygen. As FIG. 1 shows, it was found out an oxygen content of the ingot with no deoxidant added was 1000 ppm, which is higher than an oxygen concentration in the electrolyzed Mn. Further, when 0.1 wt% of Al as a deoxidant was added, it was confirmed the oxygen content of the ingot was of the order of 400 ppm, which was turned out to be higher than the oxygen content in Example 1 when compared with the result of Example 1 where the oxygen content was 20 ppm when the Al was 0.1 wt %.

Considering the results of both Example 1 and Comparative Example 1, it became clear that 0.1 wt % or more of a deoxidant was required to be added to ensure the oxygen concentration in an Mn ingot be 100 ppm or lower.

### EXAMPLE 2

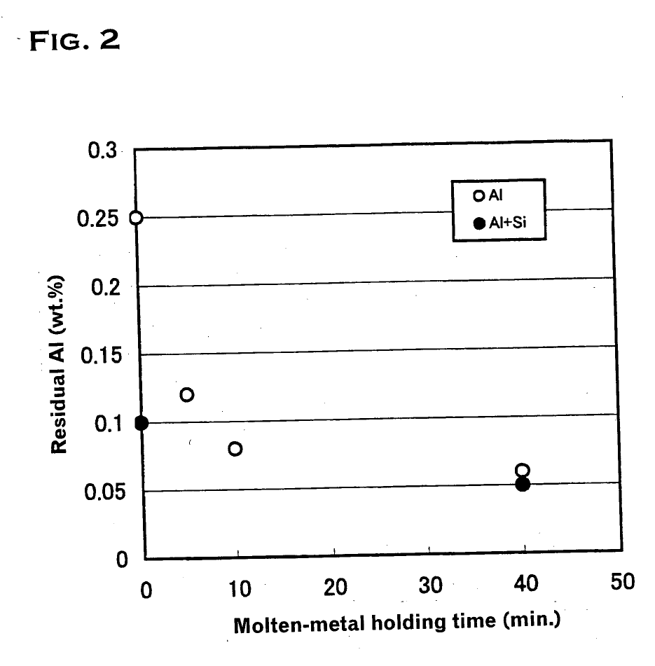

In Example 2, it will be described about measurement results of a relation between a melting time of Mn and residues of oxides in a Mn ingot which was generated with an addition of deoxidant. 0.1 wt % of deoxidant Al was added to a 1000 g of electrolyzed Mn which is identical to that in Example 1, melted in a calcia crucible for a predetermined time, and cast to a Mn ingot, and an Al concentration in the ingot was measured. FIG. 2 shows a graph in which plotted is a relationship between a melting time and Al concentration in an ingot where the temperature of the molten metal was kept constant at 1350° C. but the melting time, i.e. a holding time of the molten metal was fluctuated. As is understood from the graph, it was turned out the residual volume of Al drastically decreased when the holding time of the molten metal reached 5 minutes, and subsequent rate of decrease was saturated.

Further, when 0.1 wt % of a compound additive Si was added to 0.1 wt % of a deoxidant Al and Al concentration in a Mn ingot was measured, it was turned out that the Al concentration in a Mn ingot further decreased when the holding time of the molten metal reached 40 minutes, compared with a case where only Al was added.

From the above results, it became clear that adjustment of a melting time, i.e. a holding time of the molten metal was able to reduce the residual volume in a Mn ingot of an oxide generated due to addition of a deoxidant, even if the deoxidant was added. This is considered ascribable to a phenomenon where the deoxidant Al reacted with oxygen in Mn to produce an oxide, which is lighter than Mn molten metal in terms of specific gravity and hence caused floatation of the oxide to a surface of the molten metal. It also became clear that further addition of such a compound additive as Si will promote removal of an oxide generated. This is assumed ascribable to either phenomenon where the compound oxide became easily separable from the Mn molten metal due to a change in surface energy or in basicity of the Mn molten metal and the compound oxide, or oxidation of the deoxidant was promoted.

### EXAMPLE 3

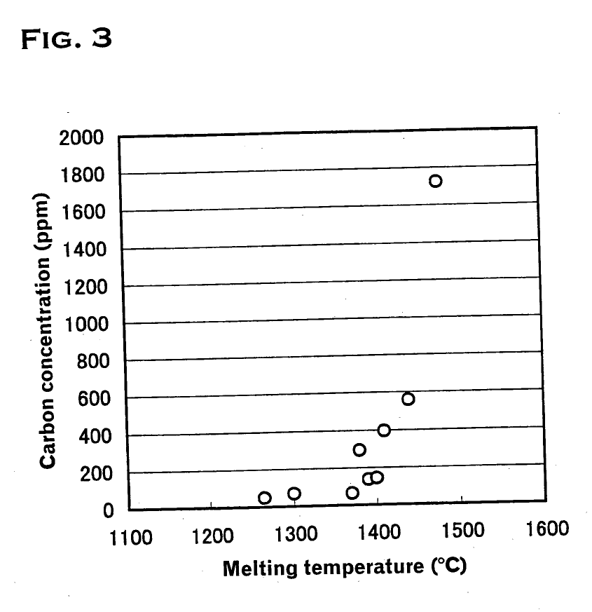

In Example 3, it will be described about results of a search conducted with regard to melting temperatures in casting low-oxygen Mn. 0.1 wt % of deoxidant Al was added to a 1000 g of electrolyzed Mn, melted in an Ar atmosphere in a calcia crucible, cast in an a carbon casting mold to a Mn ingot, and a carbon concentration in the ingot was measured. FIG. 3 is a graph showing a carbon concentration in the ingot under conditions that a melting time, i.e. a holding time of the molten metal was kept constant at 5 minutes but the melting temperatures were fluctuated. As FIG. 3 shows, it was turned out the carbon concentration drastically increased when the melting temperature, i.e. casting initiation temperature exceeded the melting point of Mn 1246° C. by +150° C., i.e. 1400° C. This is assumed ascribable to that amount of solid-soluted carbon in the Mn ingot increases because the time required for solidification of Mn molten metal is lengthened as the melting temperature (casting-initiation temperature) rises after the casting has been initiated.

### EXAMPLE 4

In Example 4, it will be described about production results of sputtering targets of Pt—Mn alloy and of Ni—Mn alloy through mixing Pt or Ni as a sputtering-constituent metal, and adding deoxidant to low-oxygen Mn having an oxygen content of 8 ppm obtained in Example 1 (deoxidant of Al 0.0 wt %; melting temperature at 1350° C.; and melting time period for 10 minutes). The composition ratio was adjusted to become Pt or Ni:Mn=60 at %:40 at %. After a low-oxygen ingot had been prepared in a manner as described in Example 1, the low-oxygen ingot was mixed with either Pt or Ni so as to provide the above-described composition ratio, added deoxidant Al by 0.1 wt %, charged the ingot into a calcia crucible, and melted it in a vacuum melting furnace. Then, the molten Mn alloy was cast into a casting mold, which have different solidification ratios. Specifically, this casting mold has at a bottom thereof a copper plate having a greater thermal diffusivity, and at a side thereof a carbon plate having a smaller thermal diffusivity than that of the copper plate. The casting mold used in Example 4 has a difference in solidification rate (approximately 50 mm/sec.) between the bottom (solidification initiating side) and the upper region (solidification terminating side) in the casting mold.

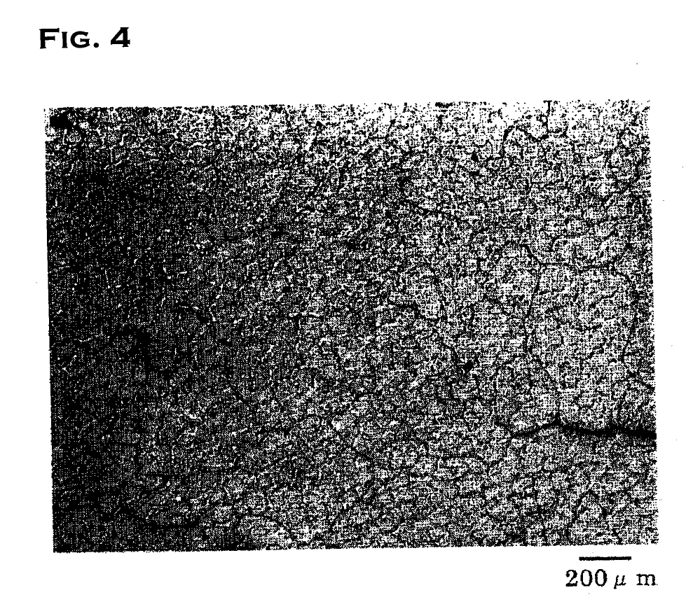

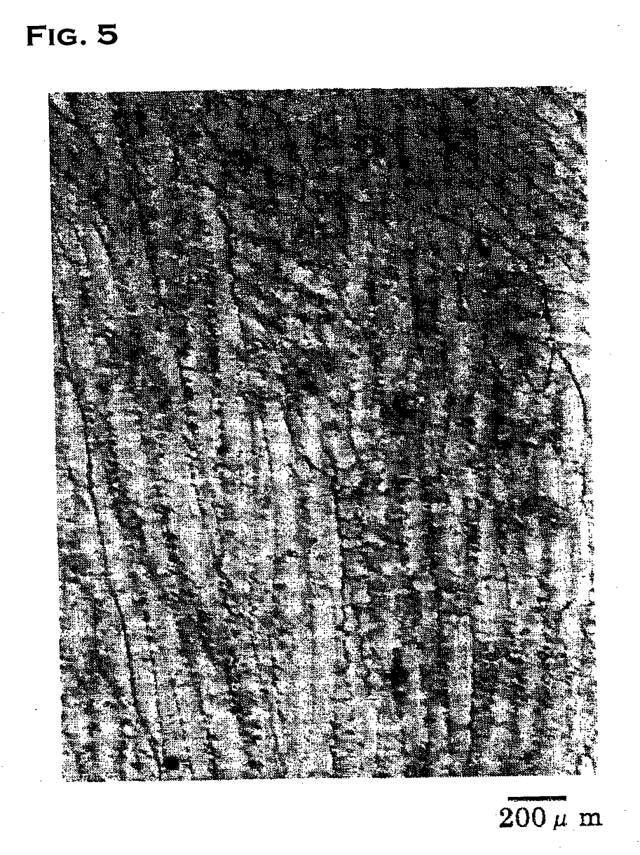

FIG. 4 is a photomicrograph taken with an optical microscope, which shows a surface of a material (solidification terminating side) of a platy Ni—Mn alloy sputtering target obtained through use of a casting mold having solidification rate differential. That is to say, the observed surface shown here is a sputtered face of the sputtering target. Through this observation, it turned out the crystals constituting the sputtered face have an average grain size of the order of 100 μm. FIG. 5 is a photomicrograph taken with an optical microscope, which shows a cross section of the material of the platy sputtering target as observed in FIG. 4. The downside in the photomicrograph shows the bottom side of the casting mold. As will be understood from FIG. 5, it turned out crystals are growing in a columnar manner from the bottom side of the casting mold.

It is to be noted that no cracks or the like were confirmed in the material in se when the sputtering target shown in FIGS. 4 and 5 was cut and observed.

Further, when the Ni(60 at %)-Mn(40 at %) alloy sputtering target obtained through the above production method was analyzed in terms of impurity gas component, it was confirmed the carbon content was 10 ppm, oxygen content was 7 ppm, and nitrogen content was 2 ppm.

### COMPARATIVE EXAMPLE 2

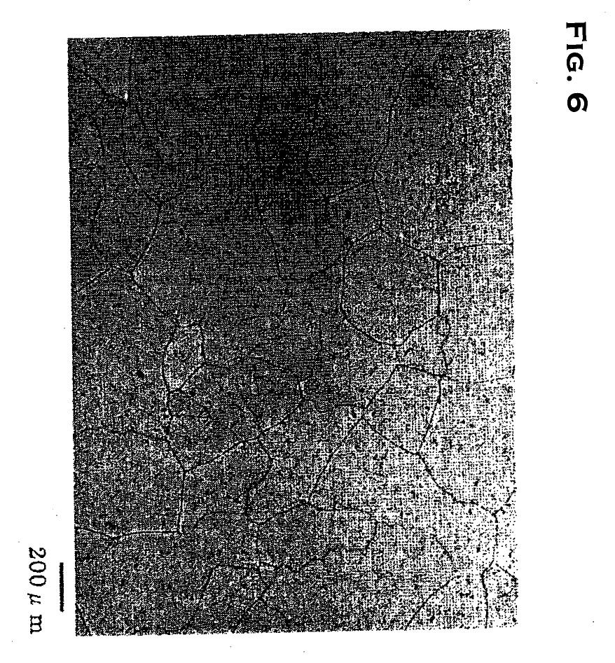

For the sake of comparison, all-carbon made casting mold was used to produce Pt—Mn alloy sputtering target. FIG. 6 is a photomicrograph taken with an optical microscope, which shows a surface of a material (solidification terminating side) of a platy Ni—Mn alloy sputtering target produced with the all-carbon made casting mold. As will be understood from the photomicrograph, it was confirmed that the crystals constituting the sputtered face were large, having an average grain size of 400 μm or larger. When the cross section of the material of the platy sputtering target observed in FIG. 6, it was confirmed the cross-section structure was equiaxed crystal.

When the sputtering target shown in FIG. 6 was cut and observed, cracks or the like were confirmed in the material in se, so that it was very difficult to process the material to desired shapes.

### COMPARATIVE EXAMPLE 3

In Comparative Example 3, a Ni—Mn alloy sputtering target was produced through the production method as described in Example 4, in which however no deoxidant was added but vacuum melting was conducted in a calcia crucible, and the target obtained was analyzed in terms of impurity gas component. The producing condition, composition of the target, and the like in Comparative Example 3 were identical to those in Example 4. The analysis results of the impurity gas component revealed, in a case where a calcia crucible was used and deoxidant was not added, the carbon content was 10 ppm, oxygen content was 92 ppm, and nitrogen content was 33 ppm. In contrast, in a case where a magnesia crucible was used and deoxidant was not added, the carbon content was 15 ppm, oxygen content was 180 ppm, and nitrogen content was 87 ppm.

1. A method of producing a Mn alloy sputtering target, comprising the steps of: adding deoxidant to Mn, the deoxidant comprising elements having stronger affinity for oxygen than that of Mn; subjecting the Mn to a deoxidization-melting treatment in a fire-resistant crucible to prepare low-oxygen Mn, in which Mn is melted to allow oxide generating due to the added deoxidant to float from the Mn molten metal; mixing the low-oxygen Mn with constituent metals of a sputtering target by respective predetermined amounts;
adding the deoxidant to the mixture;
vacuum melting the mixture; and
subjecting the mixture to a casting treatment.

2. The method of producing a Mn alloy sputtering target according to claim 1, wherein the deoxidant comprises at least one or two or more elements selected from the group consisting of Al, Ti, Ca, Mg, Ce, Si, B, V, Zr, and Hf.

3. The method of producing a Mn alloy sputtering target according to claim 1, wherein the deoxidant is added by 0.1 wt % -2.0 wt %.

4. The method of producing a Mn alloy sputtering target according to claim 1, wherein the deoxidization-melting treatment is conducted at melting temperatures ranging from 1260° C. to 1400° C.

5. The method of producing a Mn alloy sputtering target according to claim 4, wherein the deoxidization-melting treatment is conducted for 1 minute or longer.

6. The method of producing a Mn alloy sputtering target according to claim 1, wherein at least one or two or more elements selected from the group consisting of Si, B, Ba, Zr, Na, Ca, Mg, Ti, and Hf is/are added as a compound additive to the deoxidant.

7. The method of producing a Mn alloy sputtering target according to claim 1, wherein the casting treatment comprising the steps of: charging the vacuum-melted molten metal into a casting mold, which has a difference in solidification rate between a solidification initiating side thereof and a solidification terminating side thereof; and solidifying the molten metal so as to provide an oriented columnar crystal and fine crystal grains at the solidification initiating side.

8. The method of producing a Mn alloy sputtering target according to claim 7, wherein the casting treatment is conducted at melting temperatures ranging from 1380° C. to 1900° C.

9. The method of producing a Mn alloy sputtering target according to claim 1, wherein the constituent metals of a sputtering target are at least one or two or more elements selected from the group consisting of Pt, Ir, Ni, Pd, Rh, Ru, Os, Cr, Re, Co, V, Nb, Ta, Cu, Ag, Au, Mo, and W.

10. The Mn alloy sputtering target obtained through the method as defined in claim 1, wherein an oxygen content is 100 ppm or less, a carbon content is 200 ppm or less, and crystal grain size at a sputtered surface side of the sputtering target is 200 ppm or smaller.

11. The Mn alloy sputtering target according to claim 10, wherein a nitrogen content is 10 ppm or less.
